(19) United States
(12) Patent Application Publication
(10) Pub. No.: US 2011/0173297 A1
(43) Pub. Date: Jul. 14, 2011

(54) METHOD OF CONTROLLING INFORMATION PROCESSING SYSTEM, INFORMATION PROCESSING DEVICE AND INFORMATION PROCESSING SYSTEM

(75) Inventor: Akihiro MORIYA, Kawasaki (JP)

(73) Assignee: Fujitsu Limited, Kawasaki (JP)

(21) Appl. No.: 13/071,806

(22) Filed: Mar. 25, 2011

Related U.S. Application Data
(63) Continuation of application No. PCT/JP2008/003402, filed on Nov. 20, 2008.

(51) Int. Cl. G06F 15/16

(52) U.S. Cl. 709/217

(57) ABSTRACT

A method of controlling an information processing system including a first information processing device and a second information processing device the method has updating a control program held in a first storage device by the first information processing device, sending information on the updated control program from the first information processing device to the second information processing device, receiving the information on the updated control program by the second information processing device, comparing information on a control program held in the second information processing device with the information on the updated control program, sending a request from the second information processing device to the first information processing device to deliver the updated control program, sending the updated control program from the first information processing device to the second information processing device, and storing the updated control program sent from the first information processing device in a second storage device.

### CROSS-REFERENCE TO RELATED APPLICATION

This is a continuation of Application PCT/JP2008/003402, filed on Nov. 20, 2008, the entire contents of which are incorporated herein by reference.

### FIELD

The present art relates to a method of controlling information processing system, an information processing device and an information processing system.

### BACKGROUND

As one of information processing devices, a sever device is available and the number of information processing devices, each including a plurality of server devices, is now being more and more increased. In an information processing system as described above, the number of server devices to be maintained and repaired is increased with increasing the number of sever devices included in the system. Thus, time taken for maintenance of the entire information processing system is also increased with increasing the number of server devices included in the system. However, it is difficult to completely stop the operation of the entire information processing system for reasons that the information processing system is desirably to be operated 24 hours a day. In addition, it is also desired to reduce the time taken for maintenance of the entire system.

For example, in the case that a malfunction which would be derived from the operation of firmware that functions as a control program used to control the operation of a server device has occurred in that server device, it may sometimes occur that updating of the firmware is unavoidable in order to cope with the malfunction occurred in the server device. It is unavoidable to stop the operation of the server device in order to update the firmware of the server device and much time is taken to update the firmware. The time taken to update the firmware of the server device may lead to an increase in time taken for maintenance of the entire information processing system. Thus, it may be said with respect to the time taken to update the firmware that the shorter the better.

Under the above mentioned circumstances, in the case that the firmware of each server device included in an information processing system is to be updated, each server device receives firmware from a firmware delivery device that manages firmware and delivers the firmware to each server device. Then, the firmware of each server device is rewritten to the received firmware. However, in order to update the firmware of each server device by using a method as mentioned above, it may be desirable to construct a new system by incorporating the firmware delivery device into the information processing system.

As examples of related art, Japanese Laid-open Patent Publication No. 2005-228289 and Japanese Laid-open Patent Publication No. 2006-235739 are disclosed.

### SUMMARY

According to an aspect of an embodiment, a method of controlling an information processing system including a first information processing device and a second information processing device that are connected with each other, the method has updating a control program held in a first storage device by the first information processing device, sending information on the updated control program from the first information processing device to the second information processing device, receiving the information on the updated control program by the second information processing device, comparing information on a control program held in the second information processing device with the information on the updated control program that the second information processing device has received, sending a request from the second information processing device to the first information processing device to deliver the updated control program when the received information on the updated control program is different from the information on the control program held in the second information processing device, sending the updated control program from the first information processing device to the second information processing device when the first information processing device has received the request to deliver the updated control program, and storing the updated control program sent from the first information processing device in a second storage device by the second information processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an information processing system according to an embodiment of the present art;

FIG. 2 is a diagram illustrating an example of a configuration of an information processing device according to the embodiment;

FIG. 3 is a diagram illustrating an example of a detailed configuration of an information processing device according to the embodiment;

FIG. 4 is a diagram illustrating an example of a configuration of delivery firmware (firmware to be delivered);

FIG. 5 is a diagram illustrating an example of the outline of processes executed using the information processing system;

FIG. 6 is a diagram illustrating an example of a first part of a flowchart of a firmware updating process;

FIG. 7 is a diagram illustrating an example of a second part of the flowchart of the firmware updating process;

FIG. 8 is a diagram illustrating an example of a first part of a flowchart of a firmware updating process executed when an information processing device is added;

FIG. 9 is a diagram illustrating an example of a second part of the flowchart of the firmware updating process executed when the information processing device is added;

FIG. 10 is a diagram illustrating an example of a configuration of an information processing system;

FIG. 11 is a diagram illustrating an example of a configuration of an information processing system; and

FIG. 12 is a diagram illustrating an example of a configuration of an information processing system.

### DESCRIPTION OF EMBODIMENTS

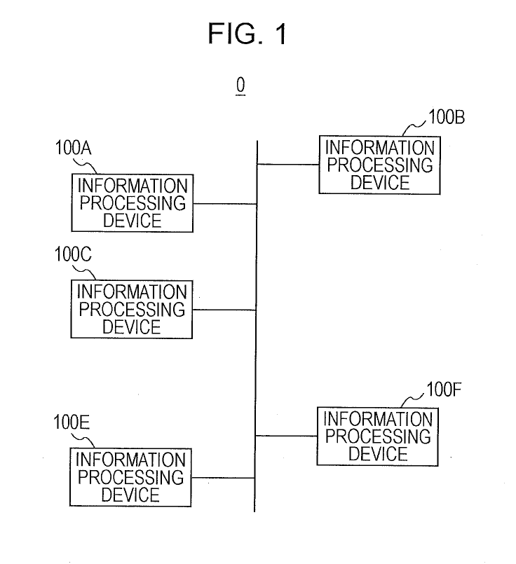

Next, a preferred embodiment will be described with reference to the accompanying drawings. FIG. 1 is a diagram illustrating an example of a configuration of an information processing system according to the embodiment. An information processing system 0 includes a plurality of information processing devices 100A, 100B, 100C, 100E and 100F.

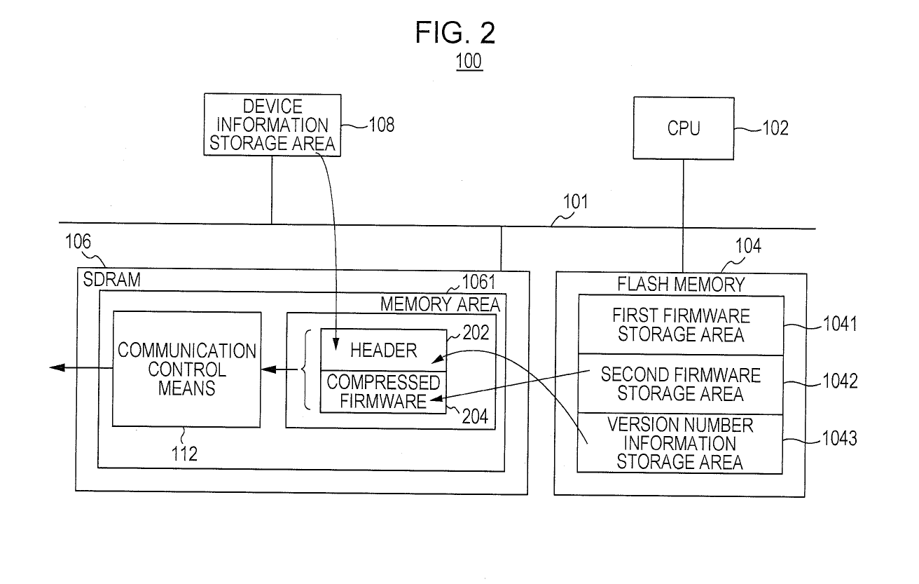

FIG. 2 is a diagram illustrating an example of a configuration of an information processing device 100 according to the embodiment. The information processing device 100 includes a CPU (Central Processing Unit) 102, a flash memory 104, an SDRAM (Synchronous Dynamic Random Access Memory) 106, a device information storage area 108 and a bus 101. The flash memory 104 which is installed as a storage unit includes a first firmware storage area 1041, a second firmware storage area 1042 and a version number information storage area 1043. The SDRAM 106 includes a memory area 1061. The first firmware storage area 1041 and the second firmware storage area 1042 store firmware used to control the operation of the information processing device 100.

The version number information storage area 1043 stores version number information of firmware stored in the first firmware storage area 1041 and the second firmware storage area 1042.

The CPU 102 expands the firmware which is stored in one of the first firmware storage area 1041 and the second firmware storage area 1042 in a memory area 1061 of the SDRAM 106 to execute the firmware. The information processing device 100 comes to function as version number managing means 110, communication control means 112, firmware updating means 114, firmware generating means 116 and firmware delivery destination (delivery source and sink) setting means 118.

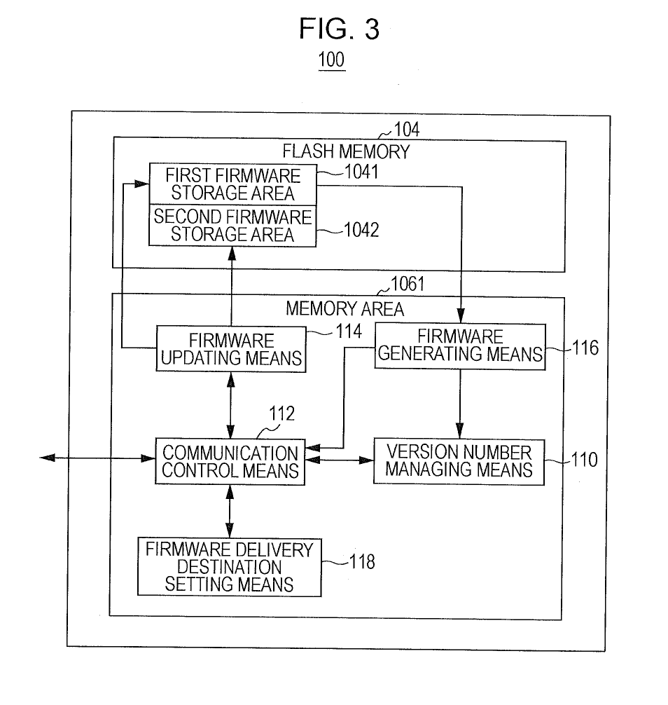

FIG. 3 is a diagram illustrating an example of a detailed configuration of the information processing device 100 according to the above mentioned embodiment. Incidentally, the same numerals are assigned to the same elements as those described with reference to FIG. 2 and description thereof will be omitted.

The version number managing means 110 manages version number information of firmware stored in the first firmware storage area 1041 and the second firmware storage area 1042. In addition, the version number managing means 110 receives version number information of firmware from one information processing device via the communication control means 112 and compares the version number information of the firmware stored in the first firmware storage area 1041 and the second firmware storage area 1042 with the received version number information of new firmware. In the case that the received version number information of the firmware is different from the version number information of the firmware that the information processing device 100 holds as a result of comparison, the version number managing means 110 sends the information processing device that has sent the version number information to the device 100 a request to deliver the firmware via the communication control means 112. The reason for the above lies in that the received version number of the firmware is newer than the version number of the firmware that the information processing device 100 holds and hence it is desirable to deliver the received firmware to another information processing device.

The firmware delivery destination setting means 118 registers IP (Internet Protocol) addresses of information processing devices to which the firmware will be delivered.

The communication control means 112 sends another information processing device a notification that firmware has been updated using an SNMP (Simple Network Management Protocol) trap, delivers firmware to another information processing device using HTTP (Hypertext Transfer Protocol) and notifies another information processing device of version number information of the firmware concerned using the SNMP trap. The communication control means 112 receives firmware from another device. In addition, in the case that a request for firmware delivery or the like has been made from an information processing device the IP address of which is not set in the firmware delivery destination setting means 118, the communication control means 112 sets that IP address which has not been set so far in the firmware delivery destination setting means 118. As described above, the communication control means 112 communicates with other devices in the above mentioned manner.

The firmware generating means 116 receives firmware from another device via the communication control means 112 and rewrites firmware which is not expanded in the memory area 1061 in the firmware stored in the first firmware storage area 1041 and the second firmware storage area 1042 to the received firmware. In the case that the rewritten firmware is expanded in the memory area 1061 and the information processing device 100 starts up normally, the CPU 102 rewrites not-rewritten firmware to the received firmware. At the completion of execution of firmware rewriting, the firmware generating means 116 notifies the version number managing means 110 of the version number information of the rewritten firmware.

The firmware generating means 116 expands firmware which is not expanded in the memory area 1061 in the firmware stored in the first firmware storage area 1041 and the second firmware storage area 1042 in the memory area 1061. The firmware generating means 116 compresses the firmware which is expanded in the memory area 1061 so as to have a size which is small enough to deliver the firmware with ease. The firmware generating means 116 acquires information used to specify the information processing device 100 from the device information storage area 108 and acquires the version number information of the firmware from the version number managing means 110. Then, the firmware generating means 116 combines the device information (the information used to specify the information processing device 100), the version number information of the firmware and the check sum of the compressed firmware with one another to generate a header. Finally, the firmware generating means 116 combines the generated header with the compressed firmware to generate one piece of delivery firmware 200.

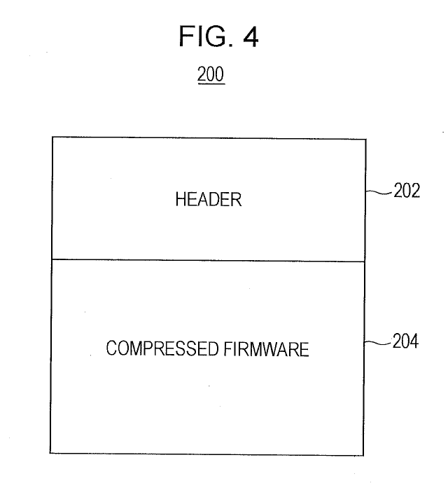

FIG. 4 is a diagram illustrating an example of a configuration of the delivery firmware 200. The delivery firmware 200 includes a header 202 and compressed firmware 204. The size of the delivery firmware including the header, information on the date that the delivery firmware has been generated, the type of the firmware, version number information of the firmware, information on a device that the firmware supports and the check sum of the compressed firmware are included in the header 202.

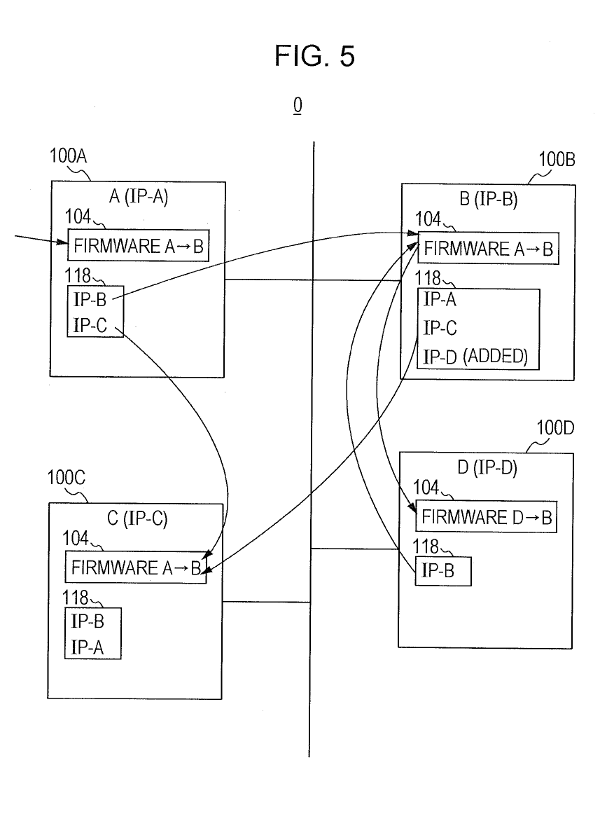

FIG. 5 is a diagram illustrating an example of the outline of processes executed using the information processing system according to the above mentioned embodiment. The information processing system 0 includes four information processing devices such as, for example, the information processing device 100A, the information processing device 100B, the information processing device 100C and an information processing device 100D. In the embodiment, an example in which the information processing device 100D is added to the information processing system including the information processing devices 100A, 100B and 100C will be described.

The IP addresses which are the destination addresses of the information processing device 100B and the information processing device 100C are designated in the firmware delivery destination setting means 118 of the information processing device 100A. The IP addresses of the information processing device 100A and the information processing device 100C are designated in the firmware delivery destination setting means 118 of the information processing device 100B at a time point that the information processing system operates. The IP addresses of the information processing device 100B and the information processing device 100A are designated in the firmware delivery destination setting means 118 of the information processing device 100C.

First, the firmware of the information processing device 100A is updated. The information processing device 100A refers to the firmware delivery destination setting means 118 and acquires the IP addresses of information processing devices to which a notification that its firmware has been updated will be sent. Then, the information processing device 100A sends the information processing device 100B and the information processing device 100C the notification that its firmware has been updated. Then, the information processing device 100A delivers delivery firmware which has been generated in its own device (the device 100A) to the information processing device 100B and the information processing device 100C.

The information processing device 100B receives the notification from the information processing device 100A and in the case that it is judged that updating of its firmware is desirable as a result of checking up the version number information of the firmware, updates the firmware of its own device (the device 100B) to the firmware received from the information processing device 100A. The information processing device 100B refers to the firmware delivery destination setting means 118 and sends the information processing device 100C a notification that its firmware has been updated. Incidentally, since the information n processing device 100B has received the notification that the firmware has been updated from the information processing device 100A, it does not send the information processing device 100A the notification that its firmware has been updated.

Next, a case in which the information processing device 100D has been freshly added to the above mentioned information processing system will be described. It is supposed that the IP address which is the destination address of the information processing device 100B is designated in the firmware delivery destination setting means 118 of the information processing device 100D. In the above mentioned situation, the information n processing device 100D refers to the firmware delivery destination setting means 118 and sends the information processing device 100B a notification that whether version number information of the firmware of the information processing device 100D matches that of the information processing device 100B has been confirmed. The information processing device 100B that has received the above notification from the information processing device 100D adds the IP address of the information processing device 100D to its own firmware delivery destination setting means 118. The information processing device 100D confirms whether the version number information of its firmware matches the version number information of the firmware of the information processing device 100B and in the case it is judged that these pieces of version number information of the firmware are different from each other, receives the firmware from the information processing device 100B to update the firmware of its own device (the device 100D) to the firmware of the version number which is the same as that of the firmware of the information processing device 100B. That is, the information processing device 100B that receives a notification from a device other than devices the IP addresses of which are designated in its own firmware delivery destination setting means 118 recognizes that a new information processing device has been added to the information processing system. In the example illustrated in FIG. 5, the information processing device 100B adds the information processing device 100D to its own firmware delivery destination setting means 118 as the device that will use the firmware of its own device (the device 100B) in union as its firmware.

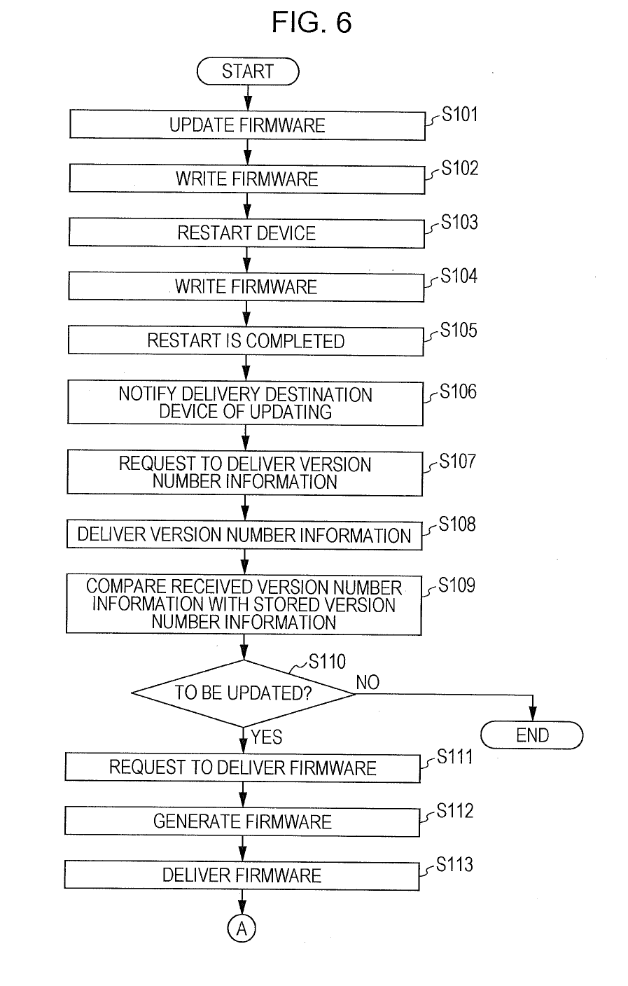

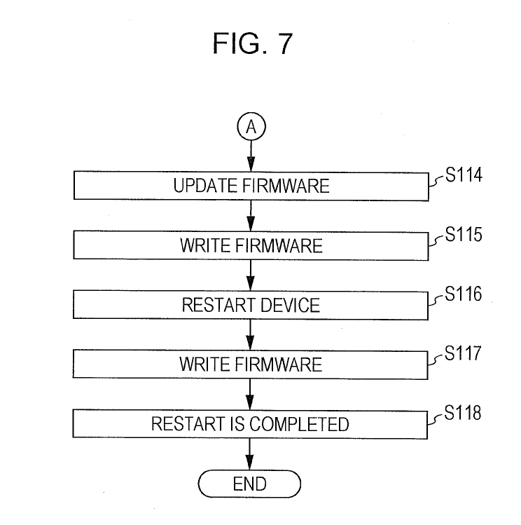

Next, a firmware updating process will be described with reference to FIG. 6 and FIG. 7.

At step S101, updating of the firmware of the information n processing device 100A is started. Then, the process proceeds to step S102.

At step S102, the updated firmware is written into one of the firmware storage areas that stores firmware which is not executed using the information processing device 100A in firmware stored in the first firmware storage area 1041 and the second firmware storage area 1042 of the information processing device 100A. In the example illustrated in the drawings, the updated firmware is written into the second firmware storage area 1042 of the information processing device 100A under the assumption that the firmware which is stored in the first firmware storage area 1041 of the information processing device 100A is executed and the firmware which is stored in the second firmware storage area 1042 of the information processing device 100A is not executed. Then, the process proceeds to step S103.

At step S103, the CPU 102 of the information processing device 100A restarts its own device (the device 100A). Specifically, the CPU 102 of the information processing device 100A restarts the information processing device 100A by expanding the firmware which has been freshly written into the second firmware storage are 1042 of the information processing device 100A at step S102 in the memory area 1061 of the information processing device 100A. Then, the process proceeds to step S104.

At step S104, the CPU 102 of the information processing device 100A writes the new firmware which is written into the second firmware storage area 1042 of the information processing device 100A into the first firmware storage area 1041 of the information processing device 100A while its own device (the information processing device 100A) is being restarted. Then, the process proceeds to step S105.

At step S105, restart of the information processing device 100A is completed. Then, the process proceeds to step S106.

At step S106, the communication control means 112 of the information processing device 100A refers to the firmware delivery destination setting means 118 of the information processing device 100A and sends an information processing device which is registered in the firmware delivery destination setting means 118 as the device to which firmware will be delivered a notification that the firmware has been updated. In the example illustrated in the drawings, the notification that the firmware has been updated is sent to the information processing device 100B which is registered in the firmware delivery destination setting means 118 of the information processing device 100A. Then, the process proceeds to step S107.

At step S107, the information processing device 100B that has received the notification that the firmware has been updated from the information processing device 100A requests the information processing device 100A to deliver version number information of the firmware to it. Then, the process proceeds to step S108.

At step S108, the information processing device 100A that has received the request to deliver the version number information of the firmware from the information processing device 100B delivers the version number information of the firmware to the information processing device 100B. Specifically, the communication control means 112 of the information processing device 100A sends the information processing device 100B the version number information of the new firmware acquired from the version number information storage area 1043 of the information processing device 100A. Then, the process proceeds to step S109.

At step S109, the information processing device 100B that has received the version number information from the information processing device 100A compares the version number information of the firmware which is stored in the information processing device 100B with the version number information of the new firmware which has been received from the information processing device 100A. Specifically, the version number managing means 110 of the information processing device 100B acquires the version number information which is stored in the version number information storage area 1043 of the information processing device 100B and compares it with the version number information of the new firmware that the communication control means 112 thereof has received from the information processing device 100A. Then, the process proceeds to step S110.

At step S110, the version number managing means 110 of the information processing device 100B judges whether updating of the firmware is desirable from a result of comparison executed at step S109. In the case that updating of the firmware is judged not to be desirable, execution of the process is terminated. On the other hand, in the case that updating of the firmware is judged to be desirable, the process proceeds to step S111.

At step S111, the communication control means 112 of the information processing device 100B requests the information processing device 100A to deliver the firmware to it. Then, the process proceeds to step S112.

At step S112, the information processing device 100A that has received the request to deliver the firmware from the information processing device 100B generates delivery firmware. Specifically, the firmware generating means 116 of the information processing device 100A expands the firmware stored in the first firmware storage area 1041 of the information processing device 100A in the memory area 1061 of the information processing device 100A and then compresses the firmware. Then, the firmware generating means 116 of the information processing device 100A generates the delivery firmware from the version number information stored in the version number information storage area 1043 and the compressed firmware. Then, the process proceeds to step S113.

At step S113, the communication control means 112 of the information processing device 100A sends the information processing device 100B the firmware which has been generated at step S112. The process proceeds to step S114 in FIG. 7.

At step S114 in FIG. 7, updating of the firmware of the information processing device 100B is started. Then, the process proceeds to step S115.

At step S115, the updated firmware is written into one of the firmware storage areas that stores firmware which is not yet executed in the firmware stored in the first firmware storage area 1041 and the second firmware storage area 1042 of the information processing device 100B. Then, the process proceeds to step S116.

At step S116, the CPU 102 of the information processing device 100B restarts its own device (the device 100B). Then, the process proceeds to step S117.

At step S117, the CPU 102 of the information processing device 100B writes the updated firmware into the firmware storage area into which the updated firmware is not written while the information processing device 100B is being restarted. Then, the process proceeds to step S118.

At step S118, restart of the information processing device 100B is completed and hence execution of the process is terminated.

Incidentally, although the process of updating the firmware of the information processing device 100B using the information processing device 100A has been described with reference to FIG. 6 and FIG. 7, the process is executed in the same manner as the above also in the case that the information processing device 100B updates the firmware of the information processing device 100C.

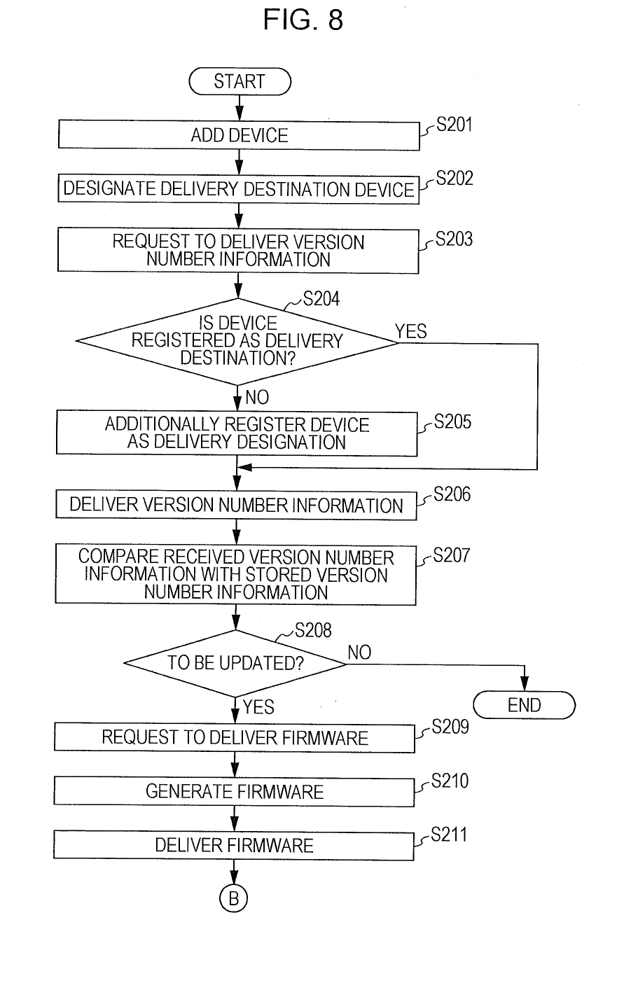

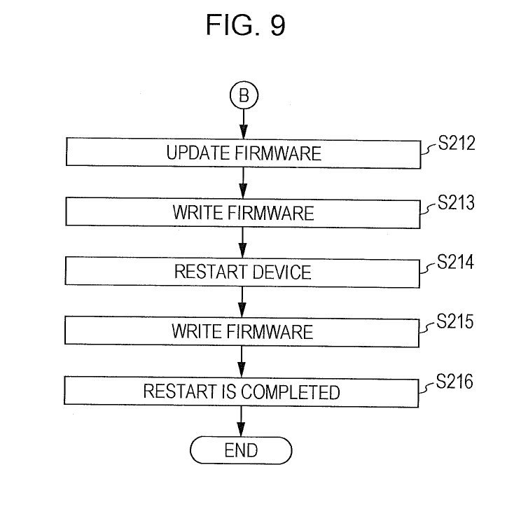

Next, a firmware updating process to be executed when an information processing device has been added to the information processing system concerned will be described with reference to FIG. 8 and FIG. 9.

At step S201, the information processing device 100D is added to the information processing system. Then, the process proceeds to step S202.

At step S202, an information processing device the version number of the firmware of which is to be matched with that of the information processing device 100D is registered into the firmware delivery destination setting means 118 of the information processing device 100D. In the example illustrated in the drawings, the information processing device 100B is registered into the firmware delivery destination setting means 118 of the information processing device 100D. Incidentally, the information processing device the version number of the firmware of which is to be matched with that of the information processing device 100D is registered, for example, by a manager of the information processing system 0. Then, the process proceeds to step S203.

At step S203, the communication control means 112 of the information processing device 100D refers to the firmware delivery destination setting means 118 of the information processing device 100D and requests an information processing device which is registered as the device from which its firmware is to be delivered to deliver the version number information of the firmware to the information processing device 100D. In the example illustrated in the drawings, delivery of the version number information of the firmware is requested to the information processing device 100B which is registered in the firmware delivery destination setting means 118 of the information processing device 100D. Then, the process proceeds to step S204.

At step S204, the communication control means 112 of the information processing device 100B refers to the firmware delivery destination setting means 118 thereof (the information processing device 100B) and judges whether the information processing device 100D is registered as the firmware delivery destination. In the case that the information processing device 100D is registered as the firmware delivery destination, the process proceeds to step S206. While, in the case that the information processing device 100D is not registered as the firmware delivery destination, the process proceeds to step S205.

At step S205, the communication control means 112 of the information processing device 100B registers the information processing device 100D as the firmware delivery destination in the firmware delivery destination setting means 118 of the information processing device 100B. Then, the process proceeds to step S206.

At step S206, the information processing device 100B that has received the request to deliver the version number information of the firmware from the information processing device 100D delivers the version number information of the firmware to the information processing device 100D. Specifically, the communication control means 112 of the information processing device 100B acquires the version number information which is stored in the version number information storage area 1043 of the information processing device 100B and sends the information processing device 100D the acquired version number information. Then, the process proceeds to step S207.

At step S207, the information processing device 100D that has received the version number information from the information processing device 100B compares the version number information of the firmware stored in the information processing device 100D with the version number information of the new firmware received from the information processing device 100B. Specifically, the version number managing means 110 of the information processing device 100D acquires the version number information stored in the version number information storage area 1043 of the information processing device 100D and compares it with the version number information of the new firmware that the communication control means 112 of the information processing device 100D has received. Then, the process proceeds to step S208.

At step S208, the version number managing means 110 of the information processing device 100D judges whether updating of the firmware is desirable from a result of comparison executed at step S207. Incidentally, for example, in the case that the firmware of the information processing device 100B is newer than the firmware of the information processing device 100D, updating of the firmware is desirable. In the case that updating of the firmware is judged not to be desirable, execution of the process is terminated. While, when updating of the firmware is judged to be desirable, the process proceeds to step S209.

At step S209, the communication control means 112 of the information processing device 100D sends the information processing device 100B a request to deliver the firmware to it. Then, the process proceeds to step S210.

At step S210, the information processing device 100B that has received the request to deliver the firmware from the information processing device 100D generates delivery firmware. Then, the process proceeds to step S211.

At step S211, the communication control means 112 of the information processing device 100B sends the information processing device 100D the firmware generated at step S210. Then, the process proceeds to step S212 in FIG. 9.

At step S212 in FIG. 9, updating of the firmware of the information processing device 100D is started. Then, the process proceeds to step S213.

At step S213, the updated firmware is written into one of the firmware storage areas that stores firmware which is not yet executed in the firmware stored in the first firmware storage area 1041 and the second firmware storage area 1042 of the information processing device 100D. Then, the process proceeds to step S214.

At step S214, the CPU 102 of the information processing device 100D restarts its own device (the device 100D). Then, the process proceeds to step S215.

At step S215, the CPU 102 of the information processing device 100D writes the updated firmware into the firmware storage area into which the updated firmware is not written while its own device (the device 100D) is being restarted. Then, the process proceeds to step S216.

At step S216, restart of the information processing device 100D is completed and hence execution of the process is terminated.

Although in the above mentioned embodiment, an example in which the firmware of the information processing device 100B is newer than the firmware of the information processing device 100D has been described, other embodiments may be conceived of. For example, in the case that a server is to be added to an existing information processing system, if the firmware of the server added to the system is newer than the firmware of an existing server included in the system, the version number of the firmware of the server added to the system may be downgraded to that of the firmware of the existing server.

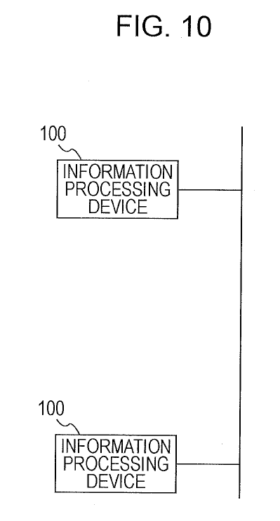

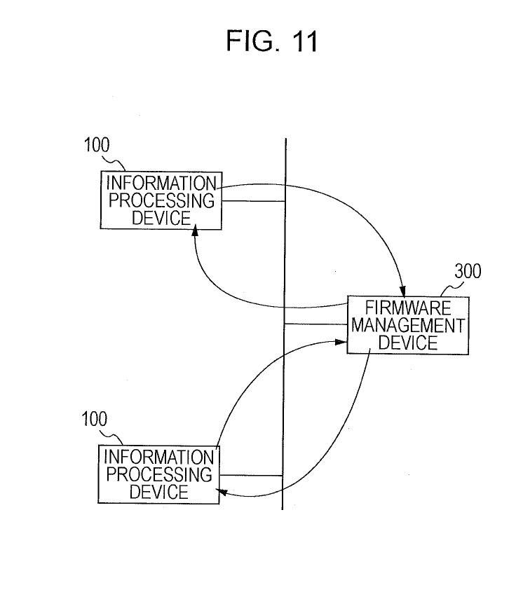

Finally, effectiveness of the above mentioned embodiment will be described. For example, it is supposed that an information processing system as illustrated in FIG. 10 is installed. The information processing system includes, for example, two information processing devices. In updating the firmware of the information processing devices, first, the firmware of one of the information processing devices is updated and after the above firmware has been updated, the firmware of the other information processing device is updated. In addition, as illustrated in FIG. 11, a firmware management device 300 is incorporated into the system to update the firmware of the information processing devices using the firmware management device 300.

On the other hand, according to the above mentioned embodiment, the firmware of each information processing device is configured to have a function of delivering the firmware and the information processing device is configured to generate the firmware to be delivered. Thus, the device for managing and delivering the firmware may be eliminated.

In addition, according to the above mentioned embodiment, it is allowed to readily change the firmware to be used in union by devices in each group by designating an information processing device to which the generated firmware is to be delivered. For example, in the example illustrated in FIG. 1, it is allowed to use one pierce of firmware in union by the information processing devices 100A, 100B and 100C included in one group and to use another piece of firmware in union by the information processing devices 100E and 100F included in another group.

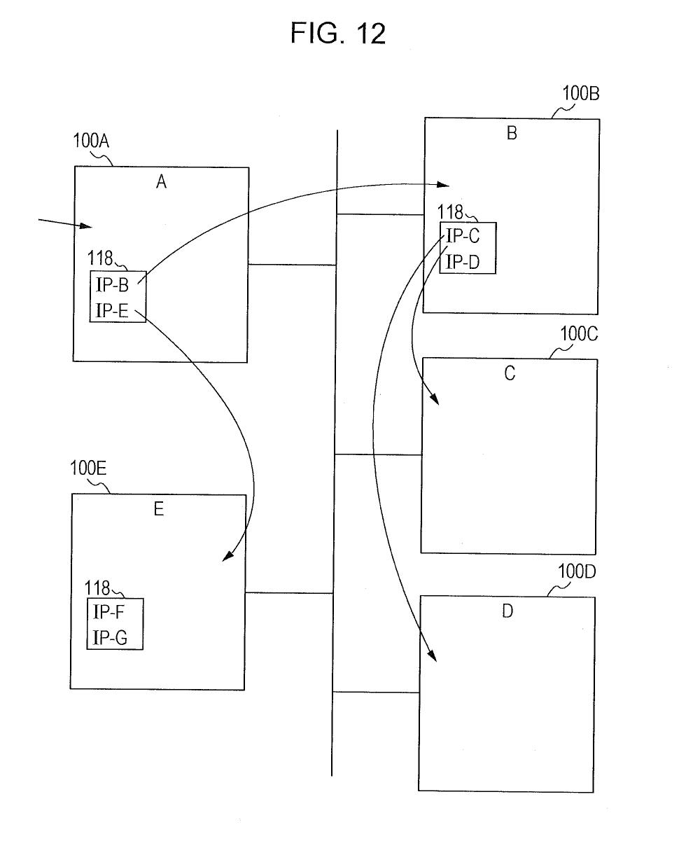

Further, for example, it is supposed that an information processing system as illustrated in FIG. 12 is installed. In the information processing system illustrated in FIG. 12, the information processing devices 100B and 100E are designated in the firmware delivery destination setting means 118 of the information processing device 100A. The information processing devices 100C and 100D are designated in the firmware delivery destination setting means 118 of the information processing device 100B. Then, the information processing devices 100F and 100G are designated in the firmware delivery destination setting means 118 of the information processing device 100E. The information processing device 100B executes a firmware updating process using the firmware which has been sent from the information processing device 100A and sends the information processing devices 100C and 100D the updated firmware. Likewise, the information processing device 100E executes a firmware updating process using the firmware which has been sent from the information processing device 100A and sends the information processing device 100F (not illustrated) and the information processing device 100G (not illustrated) the updated firmware. It is allowed to update the firmware of the entire information processing system at a high speed by sequentially updating the firmware in descending order starting from the highest-order information processing device and ending with the lowest-order information processing device in the above mentioned manner.

In the above mentioned description, the embodiment has been specifically explained just for better understanding thereof and it is not intended to limit other forms. Thus, the embodiment may be varied and altered in a variety of ways within a range of not changing the gist thereof.

According to an embodiment of the present art, one information processing device delivers firmware concerned to another information processing device. Therefore, firmware updating may be attained with no provision of a firmware delivering device dedicated to firmware delivery.

As mentioned above, the present invention has been specifically described for better understanding of the embodiments thereof and the above description does not limit other aspects of the invention. Therefore, the present invention can be altered and modified in a variety of ways without departing from the gist and scope thereof.

What is claimed is:

1. A method of controlling an information processing system including a first information processing device and a second information processing device that are connected with each other, the method comprising:
updating a control program held in a first storage device by the first information processing device;
sending information on the updated control program from the first information processing device to the second information processing device;
receiving the information on the updated control program by the second information processing device;
comparing information on a control program held in the second information processing device with the information on the updated control program that the second information processing device has received;
sending a request from the second information processing device to the first information processing device to deliver the updated control program when the received information on the updated control program is different from the information on the control program held in the second information processing device;
sending the updated control program from the first information processing device to the second information processing device when the first information processing device has received the request to deliver the updated control program; and
storing the updated control program sent from the first information processing device in a second storage device by the second information processing device.

2. The method of controlling the information processing system according to claim 1, wherein the second information processing device compares first information specifying the first information processing device with second information specifying the second information processing device and stores the updated control program in the second storage device when the first information matches the second information.

3. An information processing device that is connected to a network, comprising:
a storage device that stores a control program for controlling the information processing device supplied from the network; and
a processing device that sends information on an updated control program to another information processing device that is connected with the information processing device via the network when the control program is supplied from the network and a control program stored in the storage device is updated accordingly, and sends the updated control program to the another information processing device when a request to deliver the updated control program is received from the another information processing device.

4. An information processing system comprising information processing devices connected each other, each of the information processing devices including:
a storage device that stores a control program for controlling the information processing device, and
a processing device that updates the control program stored in the storage device and sends information on the updated control program to the other information processing device,
while when receiving an information on an updated control program from the other information processing device, the processing device compares the received information on the updated control program with information on the control program stored in own storage device, sends a request to deliver the updated control program in the case where the received information is different from the information on the control program stored in the own storage device, and stores the updated control program sent from the other information processing device in own storage device.

5. The information processing system according to claim 4, wherein the information processing device compares first information specifying the first information processing device with second information specifying the second information processing device, and stores the updated first control program that is sent from the first information processing device into the second storage device when the first information matches the second information.
